(19) United States
(12) Patent Application Publication
(10) Pub. No.: US 2011/0088854 A1
(43) Pub. Date: Apr. 21, 2011

(54) Vehicle rear window solar shade

(76) Inventor: Bruce Edward Lowe, Moreno Valley, CA (US)

(21) Appl. No.: 12/589,090

(22) Filed: Oct. 19, 2009

(51) Int. Cl. B60J 3/00

(52) U.S. Cl. 160/370.21; 160/405

(57) ABSTRACT

The present invention comprised of a flexible sunscreen and designed to be attached to the interior surface of a vehicle's rear window and configured to cover all or portions thereof for the purpose of reducing solar heat energy and ultraviolet radiation from entering into the interior compartment of said vehicle. The use of this solar shade will reduce the need for interior cooling, fuel usage and greenhouse gas emissions when used in vehicles that require interior cooling by means of mechanical air conditioning.

### BACKGROUND OF INVENTION

At this time of rising energy cost and global concerns with “greenhouse” gas emissions, in conjunction with the global expansion of automobile usage, the need arose for a relatively inexpensive way to help reduce fuel consumption and provide a degree of enhanced passenger comfort while improving a vehicle's atheistic appeal.

Rear window covers are currently used to reduce solar heat transfer into vehicles. Various methods have been successfully developed and utilized to accomplish this task. Some techniques currently used to reduce solar heat transfer are window coating with plastic film i.e., “window tinting”, screen attached to windows by means of suction cups, motorized pop-up screens integrated into vehicles, roller screens attached to window frames by means of screws and fasteners and variations thereof. Most of these devices are functional and work as intended.

Our solar screen offers the following advantages:

Is highly efficient in reducing solar heat transfer.
Is highly efficient in reducing solar and headlight glare.
Attachment is by means of Velcro tape that offers unlimited flexible; screens can be fully or partially deployed and easily re-installed and conditions dictate.
Can enhance a vehicle's atheistic appeal, as the rear window sunscreen is available in various color options and can be imprinted with logos.

### SUMMARY OF THE INVENTION

The primary objects of this invention is to provide a rear window sunshade for the purpose of reducing solar heat energy and ultraviolet radiation whereby the interior compartment of said vehicle is maintained at a cooler temperature than would be otherwise possible.

The reduction of energy i.e. “mechanical air conditioning” required to cool a vehicle's passenger compartment is directly related to the transference solar heat energy. By reducing use of mechanical energy required to cool a vehicle's passenger compartment would also decrease fuel usage and the emission of greenhouse gasses.

Additionally, the filtering of direct sunlight will aid in the comfort of all vehicle passengers but overwhelming so for those that are rear seated.

The sunscreen would also provide protection against fading and degradation of said vehicle interior components.

The flexibility of the sunscreen allows for it to be easily removed and stored when not in use.

A non-custom fit screen can also be used to cover specific area of a rear window as desired.

### BRIEF DESCRIPTION OF THE DRAWINGS

The features of the present invention which are believed to be novel are set forth in the appended claims. The present invention, both as to its organization and manner of operation, together with further objects and advantages thereof, may best be understood with reference to the following description, taken in conjunction with the accompanying drawings in which:

FIG. 1.

Shows sectional view of all components.

Solar sunscreen with Velcro tapes periphery.

Vehicle rear window.

FIG. 2.

Shows sectional view of mated surfaces.

FIG. 3.

Shows “custom fitted” solar sunscreen placement.

FIG. 4.

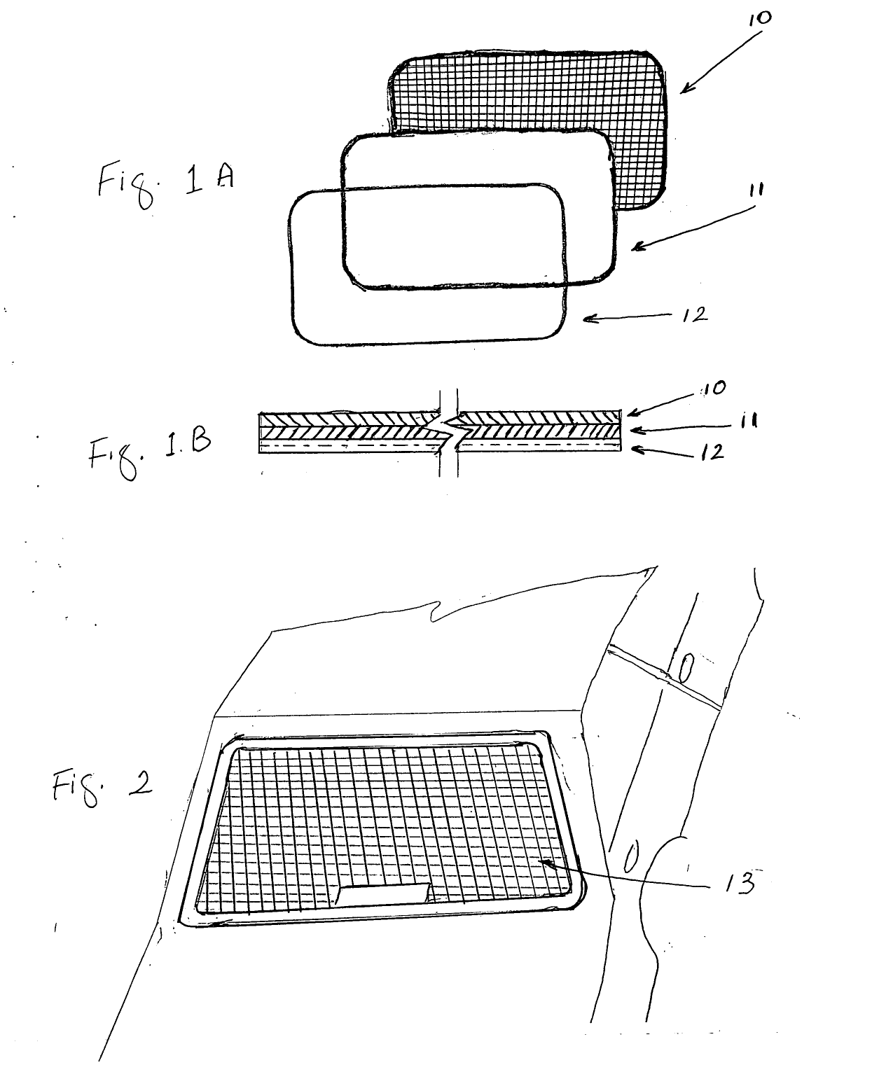

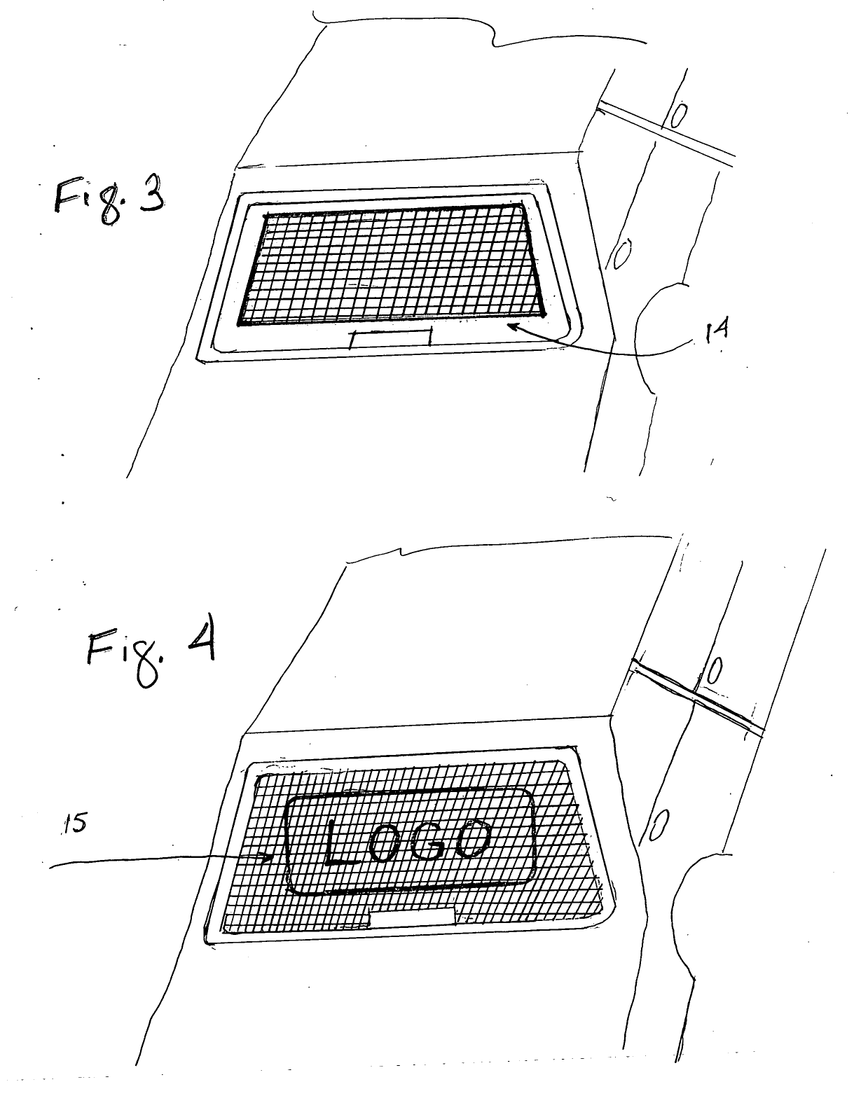

Illustrates solar screen with imprinted logo.

What is claimed:

1. A removable solar sunscreen designed to be mounted onto the interior surface of a vehicle's rear window for the purpose of inhibiting the transfer of solar heat energy and ultraviolet radiation into the interior compartment of the associated vehicle. Said device will also provide protection against the fading and degradation of interior components of said vehicle.

2. Said invention is comprised of a flexible sunscreen mesh having an outer peripheral edge of Velcro tape and a corresponding Velcro strip of identical shape and size affixed to the inner surface of said rear window. Velcro tape is used as a means for mounting and dismounting the flexible sunscreen onto the interior surface of the window. The screen can be easily removed and re-installed as dictated by conditions i.e., time of day or night, angle of sunrays, time of year, the direct and/or indirect exposure to high levels of solar heat energy and radiation or personal preference.
Screen fabric is comprised of a woven flexible mesh with high ultraviolet block designed to reduce solar heat transfer and to protect the vehicle passenger compartment from radiation while reducing sun or headlight glare.
Said screen is offered in various colors, which is intended to enhance a vehicle's atheistic appeal.
Screen can be imprinted with or without logo for personalization where copyright permits.
